(19) United States
(12) Patent Application Publication
(10) Pub. No.: US 2007/0027791 A1
(43) Pub. Date: Feb. 1, 2007

(54) Method of and apparatus for matching lenders of money with borrowers of money

(75) Inventors: Linda D. Young, Dudley (GB); David J. Nicholson, Richmond (GB); Timothy Parlett, London (GB); Simon J. Deane-Johns, London (GB)

Correspondence Address: FAEGRE & BENSON LLP;PATENT DOCKETING, 2200 WELLS FARGO CENTER, 90 SOUTH SEVENTH STREET, MINNEAPOLIS, MN, 55402-3901, US

(73) Assignee: Zopa Limited, London (GB)

(21) Appl. No.: 11/191,775

(22) Filed: Jul. 28, 2005

(51) Int. Cl. G06Q 40/00

(52) U.S. Cl. 705/37; 705/38

(57) ABSTRACT

Processes and machines for matching individual lenders with borrowers. Individual lenders can create an account having attributes defining conditions under which the individual lenders are willing to lend money. Borrowers can request quotations for loans. The borrowers and individual lenders are then matched, if possible, for the creation of a possible loan.

### BACKGROUND TO THE INVENTION

This invention relates to an automated method of matching lenders of money with borrowers of money, and an apparatus for matching lenders of money with borrowers of money.

Throughout human history, the principle of borrowing money to pay it back with interest has been well known. Borrowing is also known to take many forms; from small and simple interpersonal loans to complex arrangements involving banks and businesses.

When a borrower seeks a loan they usually investigate the various available options, seeking the lowest interest rate over the term (or duration) of loan they desire. In addition other factors such as penalties for not meeting payments may be taken into account.

A lender generally wishes to offer a competitive interest rate to borrowers, based on the credit worthiness of the borrower, the term of the loan requested, and any capital that may be claimed in the case of a default on payments.

When the lender is a bank or financial institution, borrowers tend to research the available options as advertised and match themselves with the lender they feel will offer them the lowest interest rate, or the best overall package after other factors are considered.

This system of matching may be considered undesirable by borrowers since it is time consuming and may be considered complicated. Therefore automatic systems, accessible over a computer network, have been developed to match a borrower to the lender that offers the lowest interest rate. Examples of such known systems are, for example, U.S. patent application 2003/0036993 and U.S. Pat. No. 6,611,816.

Traditional money lending-and-borrowing systems may involve a bank comprising a plurality of lenders who deposit their money in reserve and borrowers who borrow from the reserve and return their debt with interest. Such systems are inefficient for lenders and borrowers since borrowers tend to pay a greater rate of interest than is received by lenders with the difference going to the intermediary to pay for costs and profits. Furthermore in such systems lenders in particular have very little personal control over the interest they receive.

It is an intention of the current invention to provide a system and a method that maximise a lender's return on investment while simultaneously reducing the rate paid by borrowers. In addition, lenders and borrowers are provided far greater personal control of interest rates by the current invention.

Individual lenders may have personal reasons for preferring to lend directly to other people rather than than anonymous institution. Such lenders may wish to receive higher interest rates on their investments while simultaneously wishing to see individual borrowers benefit from lower interest rates. However the risks involved should a borrower default on their payments tend to prevent lenders pursuing this as an option. In traditional direct lending systems, a significant risk may be presented to the lender, especially where the borrower has a poor credit history and the loan has not been secured against any capital. In such situations, should the borrower default on their loan repayments the lender must find means to recover their due.

It is an object of the present invention to provide a method for issuing a loan to borrowers that minimises the risk presented to lenders.

### SUMMARY OF THE INVENTION

According to a first aspect of the present invention there is provided an automated method of matching lenders of money with borrowers of money, the method comprising the steps of:

receiving a plurality of offers, each offer being received from a lender of money, and each offer specifying a loan amount that the lender is prepared to lend;

dividing the loan amount from each lender into a plurality of loan units, each loan unit representing a maximum amount that can be lent to one borrower;

receiving a request for a quotation from a borrower, the request specifying an amount the borrower wishes to borrow;

matching loan units from a plurality of lenders with the borrower, wherein no more than one loan unit from any one lender can be matched with the borrower; and

outputting to the borrower a quotation based on the matched loan units.

The invention may provide the advantage that the risk of a borrower defaulting on repayments is shared by a plurality of lenders. This ensures that the level of risk assumed by any individual lender against any individual borrower is capped. The size of the cap is equal to a loan unit.

The invention may also provide the advantage that a direct link can be established between borrower and lender. Therefore it may be possible for lenders to receive a higher rate of interest and for borrowers to pay back a lower rate of interest than is generally achievable in indirect lending systems, such as may be operated by banks. Furthermore it may be considered preferable by lenders and borrowers to have more direct control over the destination and source of their money. Often in indirect systems there is no control for borrowers or lenders in these matters.

The size of a loan unit may be a configurable parameter used to set the level of risk taken by each lender.

Preferably each lender specifies a reserve rate of interest, and each loan unit has the reserve rate of interest of the lender associated with it. In this way, the lender may specify a reserve (or minimum) rate of interest for a loan so that all lending will occur at least at this rate of interest. This can enable the lender to control their money, since the lender is able to set interest rates for loans so as to compete with other lenders. This may allow the lender to maintain direct control of their investments and to increase or decrease their income by carefully setting the reserve rate of interest specified.

The matching step may comprise matching loan units having the lowest reserve rate of interest with the borrower. In this way, borrowers' loan requests may be populated with loan units of lowest reserve rate. This may produce the advantage that lenders who offer lower reserve rates are rewarded since it is more likely that their loan units will be used to populate borrowers' loan requests. Therefore lenders are encouraged to compete with one another to offer low reserve rates so that their loan amounts will become rapidly depleted by borrower requests. This produces a competitive market that should provide satisfactory interest rates to both borrowers and lenders.

The method may further comprise the step of ranking loan units in order of lowest reserve rate of interest, and the step of matching loan units may comprise matching loan units in accordance with their ranking. Thus, a loan request may be matched first with a loan unit from the lender with the lowest offered reserve rate. The loan request may then be matched with a loan unit from the lender with the second lowest minimum loan rate, and so forth until the loan request is completed. In this way a market supply curve may be created, whereby the sum of money available increases with the rate. A borrower therefore pays higher rates the more money they borrow; this is considered appropriate since higher borrowing amounts to higher risk.

Loan units having the same reserve rate of interest may be ranked in order of the time at which the offer was made. In this way, lenders who make earlier offers are rewarded since their loan units will be used in preference to lenders who make later offers. This helps to reduce the spread in length of time that lenders' loan units remain un-borrowed. A queuing method of this kind may reduce the chance that any one lender's loan units will remain un-borrowed for a long period of time.

Preferably the quotation specifies a rate of interest. In this way the borrower may be able to make a choice about whether to accept the offered loan or not on the basis of the rate of interest. The specified rate of interest is preferably the reserve rate of the loan unit having the highest reserve rate needed to achieve the amount to be borrowed. By using this method, the procedure from a borrower's perspective may be simple since they pay only one rate of repayment on their loan. However the aware borrower can amend their input parameters to test the market supply curve and achieve greater personal control in their borrowing.

Preferably all lenders having a loan unit matched to the borrower receive the specified rate of interest for the matched loan unit. This ensures that a lender is unlikely to be penalised for offering a low reserve rate. In addition this can allow lenders to select their reserve rates tactically. For example, by setting a high reserve rate, a lender may achieve high returns; however since borrowers' loan amounts are populated first with loan units of the lowest offered reserve rate, it may take a long time for the lender's loan amount to be depleted by borrowers. This may be undesirable since during the time that money is not being borrowed it is not generating interest for the lender. By setting a low reserve rate, a lender's loan amount is likely to be rapidly depleted by borrowers seeking loans. However, the lender will have to trust that the activities of other lenders will produce a market supply curve that will provide them with a satisfactory interest rate. Thus lenders may gain greater personal control of their investments.

Alternatively, all lenders having a loan unit matched to the borrower may receive the rate of interest specified by the lender, and the quotation may specify a rate of interest based on the rate of all matched lenders. Such an arrangement may provide the borrower with a better rate of interest and hence may encourage borrowers to take out loans.

In some cases it may not be possible for the loan request to be met precisely by combinations of loan units. Therefore the matching step may comprise matching part of a loan unit with the borrower.

The method may further comprise the step of dividing each of said plurality of loan units into a plurality of loan lots. By dividing a loan unit into a plurality of loan lots, it may be possible for a loan request to be met precisely by combinations of loan lots from individual lenders. Thus loan units may comprise indivisible loan lots, and all loan transactions may be undertaken in multiples of loan lots. Each loan lot may maintain a direct link with its associated lender and may have a lender defined reserve rate associated with it. By setting a minimum building block the system may be simplified and can be considered as comprising a large number of loan lots each with a unique address to their lender of origin.

The method may further comprise the steps of maintaining statistics concerning the level of bad debt, calculating an expected minimum return rate based on a reserve rate specified by a lender and the statistics concerning bad debt, and outputting to a lender the expected minimum return rate. In this way the lender may be provided with information concerning the minimum level of return that they can expect to receive, when statistical levels of bad debt are taken into account.

The request for a quotation from a borrower may specify a loan term. In this way the borrower may choose the length of time over which to repay the loan. This information may be used in a step of calculating monthly repayments for a borrower based on the offered interest rate and the loan term requested. The value of monthly repayments may be considered to be a more meaningful figure to the borrower than interest rate.

Each offer from a lender of money may specify a loan term. In this way a lender may specify the level of risk that they are prepared to undertake in respect of offering a loan. Generally borrowers that request longer term loans are more likely to default on payments and thus present a greater risk to lenders. More significantly, longer term loans deny a lender access to their money for a greater period of time. A lender may choose to compensate for these factors by offering a higher reserve rate to borrowers of a longer loan term. This is a further example of the degree of personal control in lending under the current method.

For example, loan terms of 12, 24 and 36 months may be available in some embodiments, although it will be appreciated that other loan terms could be used.

The method may further comprise the step 6f determining a credit rating for the borrower, and each offer from a lender of money may specify a credit rating for prospective borrowers. In this way, a lender may specify the level of risk that they are prepared to undertake in respect of offering a loan. Borrowers of a poor credit rating are statistically more likely to default on loan repayments. A lender may choose to compensate for this by offering a higher reserve rate to borrowers of a poor credit rating. This is a further example of the degree of personal control in lending under the current method.

By providing different loan terms and/or different credit ratings for borrowers, a plurality of markets may be provided, with each market being defined by the loan term and/or credit rating of the borrower. Markets may also be defined by characteristics of lenders and/or borrowers, such as age groups or hobbies of the lenders or borrowers. A lender may then specify which market they wish to lend money to, with each market generally representing a different level of risk.

Alternatively, a lender may offer money to a plurality of markets. For example, the lender may specify a different reserve rate for each of a plurality of markets, and the loan amount may be offered to each market at the specified reserve rate. In this way the offered loan amount may get exposure to borrowers in different markets. This may provide the advantage that a lender's loan amount is likely to be more rapidly depleted by borrower loan requests. This may maximise the amount of a lender's loan which is borrowed, and thus which is earning interest.

In order to determine a suitable reserve rate for each market, the method may further comprise the steps of maintaining statistics concerning the level of bad debt in each of a plurality of markets, calculating a reserve rate for each market based on a minimum return rate specified by a lender and the statistics concerning bad debt for that market, and outputting to a lender the calculated reserve rate for each market. The lender may then chose to use the calculated reserve rate, or may use a different reserve rate for each market.

For example, a lender may prefer not to offer loans to long term borrowers, but may be prepared to do so if the interest rate is high enough. By using the current method a lender may, for example, only offer loans to long term borrowers at a very high rate while simultaneously offering to short term markets at a rate consistent with market trends. In this example, it may be unlikely that the lender will ever lend to long term borrowers but should it ever happen the lender would be well rewarded.

The method may further comprise the step of comparing the reserve rate offered by a lender with specified rates of interest of recently accepted quotations, whereby it may be determined whether the reserve rate offered by a lender is consistent with current trends. In this way lenders may receive guidance as to the suitability of their loan offer. This may help to maintain a market supply curve that is fair to borrowers and lenders.

The method may further comprise the step of adding commission to the amount to be borrowed specified by the borrower. In this way it is possible for the system operator to take a fee for matching lenders with the borrowers. For example, the system operator may take a fee of 0.5% or 1%. This amount may be added to the total amount which is borrowed by the borrower. Alternatively the borrower may pay this amount separately.

The method may further comprise the step of adding an insurance premium to the amount to be borrowed specified by the borrower. In this way it is possible for the borrower to take out payment protection insurance to protect their monthly repayments. The premium for the insurance may be added to the total amount to be borrowed by the borrower.

The method may further comprise the step of receiving an acceptance of a quotation from a borrower and transferring matched loan units to a borrower's account.

In order to establish a contract between the lender and the borrower, it may be necessary or desirable for the borrower to be shown the terms of the contract, and then invited to indicate their approval. Thus the method may further comprise the steps of outputting terms of a contract for the loan to the borrower, and receiving an acceptance of the terms of said contract from the borrower. For example, the borrower may be asked to click in a box displayed on their screen to indicate their acceptance of the conditions of the loan. A contract may be established for each individual loan lot that has been matched to a borrower, or alternatively a single contract may be established for all loan lots from one lender which have been matched to the borrower.

In the event of the early repayment of a loan by a borrower, lender's returned funds may be automatically re-offered at the specified reserve rate. This may avoid the possibility that returned funds would return to a holding area where they would not generate interest for the lender. This may reduce the need for a lender continually to monitor their investment portfolio.

The method may further comprise the steps of receiving a rejection of a quotation from a borrower and receiving feedback from the borrower in respect of a quotation that would have been acceptable. This feedback functionality may allow borrowers to guide lenders and thus perhaps influence the market supply curve to be more favourable towards borrowers.

If a lender has offered a relatively small loan amount it may be preferable that they do not offer more than a certain fraction of their loan amount to any one borrower. By contrast, if a lender has offered a large loan amount then it may be preferable to limit the absolute amount lent to any one borrower, in order to diversify the risk. Thus the size of a loan unit may be dependent on the size of the loan amount. For example, if the loan amount is smaller than a predetermined value then loan units may be set as a fraction of the loan amount, whereas if the loan amount is greater than or equal to the predetermined value then loan units may be a fixed value.

As an example, if a lender has offered less than $5000 then the size of each loan unit may be set to 1/50 of the loan amount, whereas if the lender has offered more than $5000 then the size of each loan unit may be set to $100. It will be appreciated that these figures are given as examples only and other values could be used for the predetermined amount and the fraction as required.

The method steps are preferably carried out by a computer. The steps of receiving a plurality of offers, receiving a request from a borrower and outputting a quotation to the borrower may be carried out over a network, such as the Internet.

According to another aspect of the invention there is provided an automated method of matching lenders of money with borrowers of money, the method comprising the steps of:

receiving a plurality of offers, each offer being received from a lender of money, and each offer specifying a loan amount and a reserve rate of interest;

dividing the loan amount from each lender into a plurality of loan units, each loan unit representing a maximum amount that can be lent to one borrower;

receiving a request for a quotation from a borrower, the request specifying an amount to be borrowed;

matching loan units with the borrower in order to make up the amount to be borrowed, wherein loan units having the lowest reserve rate of interest are matched in order to achieve the amount to be borrowed, and wherein no more than one loan unit from any one lender is matched with the borrower, and

outputting to the borrower a quotation based on the reserve rate of interest of the loan unit having the highest reserve rate of interest needed to achieve the amount to be borrowed.

According to another aspect of the invention there is provided an automated method of matching lenders of money with borrowers of money, the method comprising the steps of:

providing a market in which lenders of money are matched with borrowers of money at agreed rates of interest;

maintaining statistics concerning agreed rates of interest at which money has been lent in the market;

receiving an offer from a lender, the offer specifying a reserve rate of interest;

comparing said reserve rate of interest specified by the lender with said statistics concerning agreed rates of interest at which money has been lent in the market; and

outputting to the lender a result of said comparison.

In this way the lender may receive guidance as to the suitability of their loan offer, which may help to maintain the market supply curve.

According to another aspect of the invention there is provided an automated method of matching lenders of money with borrowers of money, the method comprising the steps of:

providing a market in which lenders of money are matched with borrowers of money at agreed rates of interest;

receiving information from borrowers concerning rates at which they would be prepared to borrow;

maintaining statistics concerning rates at which borrowers would be prepared to borrow;

receiving an offer from a lender, the offer specifying a reserve rate of interest;

comparing the reserve rate of interest specified by the lender with said statistics concerning rates at which borrowers would be prepared to borrow; and

outputting to the lender a result of said comparison.

In this way the lender may receive guidance as to rates of interest which would be acceptable to borrowers, which again may help to maintain the market supply curve.

According to another aspect of the invention there is provided an automated method of matching lenders of money with borrowers of money, the method comprising the steps of:

providing a plurality of markets in each of which lenders of money are matched with borrowers of money at agreed rates of interest;

maintaining statistics concerning the level of bad debt in each of said plurality of markets;

receiving an offer from a lender, the offer specifying a minimum return rate that would be acceptable to the lender;

calculating a reserve rate for each market based on said minimum return rate specified by the lender and the statistics concerning bad debt for that market; and

outputting to the lender the calculated reserve rate for each market.

In this way the lender may specify a single minimum return rate that they would like to achieve, while offering their money to more than one market. The lender may be provided with suggested reserve rates for each market, which the lender is then free to accept, decline or amend. Alternatively the lender's money could be offered to the markets automatically at the calculated reserve rate for each market.

According to another aspect of the invention there is provided apparatus which matches lenders of money with borrowers of money, the apparatus comprising:

an offer receiving unit which receives a plurality of offers, each offer being received from a lender of money, and each offer specifying a loan amount;

a dividing unit which divides the loan amount from each lender into a plurality of loan units, each loan unit representing a maximum amount that can be lent to one borrower;

a request receiving unit which receives a request for a quotation from a borrower, the request specifying an amount to be borrowed;

a matching engine which matches a plurality of loan units from a plurality of lenders with the borrower, wherein no more than one loan unit from any one lender is matched with the borrower; and

an outputting unit which outputs to the borrower a quotation based on the matched loan units.

The offer receiving unit may receive a reserve rate of interest, specified by a lender, and each loan unit may have the reserve rate of interest of the lender associated with it. The matching engine may further comprise a ranking unit that ranks loan units in order of lowest reserve rate of interest. The matching engine may match loan units in accordance with their rankings determined by the ranking unit.

The outputting unit may output a quotation comprising a specified rate of interest and the specified rate of interest may be the reserve rate of the loan unit having the highest reserve rate needed to achieve the amount to be borrowed. All lenders having a loan unit matched to the borrower may receive the specified rate of interest for the matched loan unit.

The apparatus may be, for example, a suitably programmed computer, such as a server which is connected to the Internet.

The invention also provides a computer readable storage medium having stored thereon a computer program, the computer program comprising:

a program module which receives a plurality of offers, each offer being received from a lender of money, and specifying a loan amount;

a program module which divides the loan amount from each lender into a plurality of loan units, each loan unit representing a maximum amount that can be lent to one borrower;

a program module which receives a request for a quotation from a borrower, the request specifying an amount to be borrowed;

a program module which matches loan units from a plurality of lenders with the borrower, wherein no more than one loan unit from any one lender is matched with the borrower; and

a program module which outputs to the borrower a quotation based on the matched loan units.

Features of one aspect of the invention may be provided with any other aspect. Method features may be provided with apparatus aspects and vice versa.

### BRIEF DESCRIPTION OF THE DRAWINGS

Preferred features of the present invention will now be described, purely by way of example, with reference to the accompanying drawings, in which:

FIG. 1 shows an overview of a system with which the present invention may be used.

FIG. 2 shows a flow diagram of lending from a lender's perspective in an embodiment of the invention;

FIG. 3 shows a flow diagram of borrowing from a borrower's perspective in an embodiment of the invention;

FIG. 4 shows a block diagram of an apparatus in an embodiment of the invention.

FIG. 5 shows a flow diagram of lending from a lender's perspective in a second embodiment of the invention; and

FIG. 6 shows a flow diagram of lending from a lender's perspective in a third embodiment of the invention.

### DETAILED DESCRIPTION OF EMBODIMENTS OF THE INVENTION

Overview of a Lending System

Those who wish to invest their spare money in a secure environment traditionally make use of a bank. These customers can be considered as lenders who deposit their spare funds in a secure place and leave it to the discretion of the bank to manage investments. In return for their investment customers receive interest which may be far less than the actual return made by the bank.

Usually banks make money by arranging personal loans and making investments. These processes are generally invisible to the customer who has very little control in the processes. Indeed some of the banks activities may be considered unethical in the eyes of the customer if they were aware of how their money was being spent.

The system herein described permits those with spare money to lend it directly to other people. There is no controlling bank and therefore no middle man to take a share of the return.

The risk taken by lenders in lending directly to other people is potentially high should borrowers default on their payments. The system described herein minimises this risk by ensuring that a lender's money is lent to many different borrowers.

The system herein described enables borrowers to borrow at lower interest rates and lenders to lend at higher interest rates than are generally achievable in traditional indirect lending systems. Also the current system permits lenders to lend directly to other people in a secure way.

System Overview

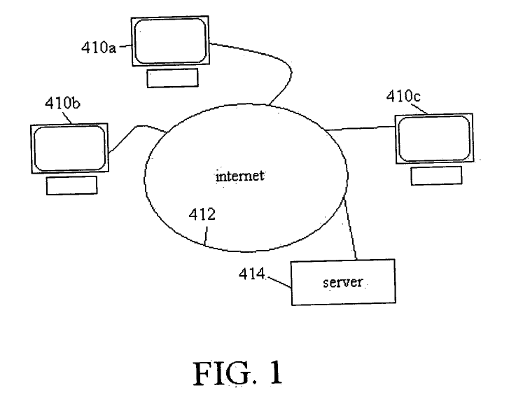

FIG. 1 shows an overview of a system where lenders and borrowers are users 410a-410c of a network 412 which may be the Internet. Although only three users are shown, it is understood that a very large number of users is possible through the Internet.

Server 414 is also connected to network 412 and is able to:

Receive HTTP requests and data from users 410a-410c;

Supply web-pages to users 410a-410c on the basis of HTTP requests received via the network 412; and

Perform calculations based on the data supplied by users 410a-410c and to supply information to users 410a-410c on web-pages. Specifically the calculations performed are related to matching lenders and borrowers in loan agreements.

Lending Process

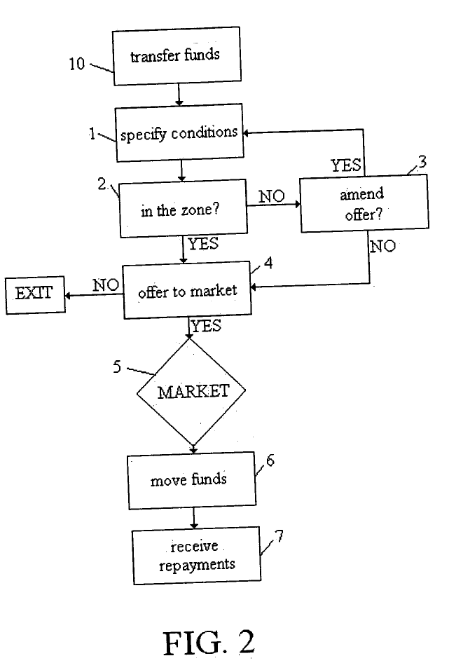

FIG. 2 shows a process that a lender goes through prior to making a loan offer in a first embodiment of the invention. The lender is a user in a computer network and the system is controlled on a server computer. In step 10 the lender transfers funds to a holding account held at a bank. Once funds in the holding account have been cleared the lender is notified, and then is able to proceed to the following steps.

At step 1 a form is displayed which may be viewed as a page on an internet browser, for example. On this form the lender creates their loan offer by defining the following parameters:

The total amount of money they are prepared to lend where the minimum amount is set as a system parameter and there is no maximum amount.

A reserve rate of interest, such that all lending will be done at this interest rate or higher.

The market that they are prepared to lend to, wherein a market comprises a plurality of similar borrowers.

Similar borrowers in the context of the current system are those who are ascribed a similar credit rating, and have requested a loan of the same term (or duration). Groupings of such similar borrowers are said to comprise markets because, statistically, they present similar risks and financial burdens to lenders. Borrowers in markets of longer term loans tend to present greater financial burdens to lenders by taking longer to return the lenders' monies. Borrowers in markets of poorer credit ratings tend to present greater risks to lenders. Accordingly, borrowers of these types tend to be charged higher interest rates for loans in compensation.

Preferably the total amount the lender is prepared to lend is in units of $500 although this is a configurable parameter.

Upon completion of step 1 the lender proceeds to step 2. In step 2 an assessment is made of whether the lender is “in the zone” with their reserve rate offer. In other words, the lender's offer is compared with statistics (for the last twenty accepted loan quotations, for example) to determine whether the lender's offer is located between the maximum and minimum interest rates of recently accepted loan quotations.

If the lender's reserve rate offer is between the maximum and minimum interest rates of recently completed loans then their offer is said to be “in the zone”; otherwise they are “not in the zone”. Details are supplied to the lender regarding whether their reserve rate offer is too high or too low. This information may also be viewed as a page on an Internet browser. It will be appreciated that the statistics governing whether an offer is “in the zone” may be reached in a variety of ways other than merely examining the last twenty accepted loan quotations.

If a lender's offer is deemed to be “not in the zone” then they may choose to amend or continue with their offer at step 3. The information exists merely by way of a guide and the lender is free to choose to continue with their offer even if it is deemed to be “not in the zone”.

As shown in FIG. 2, if a lender chooses to amend their offer at step 3, they are routed back to step 2, otherwise they are routed to step 4.

At step 4, the lender makes a final review of their loan offer and decided whether to proceed.

As will be explained in more detail below, market 5 comprises loan offers from a plurality of lenders to borrowers of known credit rating who have requested a loan of a certain term. A matching engine operates on these offers and a request from a borrower in order to supply a borrower with a quotation for a loan, comprising funds from a plurality of lenders. Upon successful match of a lender's offered funds with a borrower, the matched funds are transferred from the lender's holding account to a reserve area pending successful completion of credit and integrity checks by the borrower. Thereafter, the matched funds are transferred from the reserve area to a borrower nominated account; this is shown in generality by step 6.

Borrowing Process

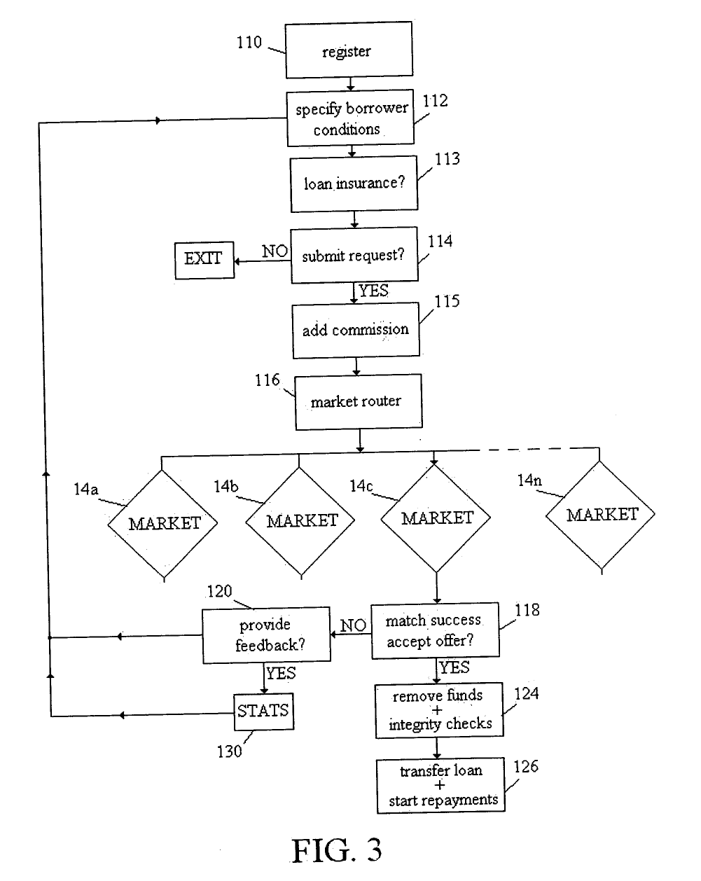

FIG. 3 shows the summary of a process in an online system that a borrower goes through in making a request for a quotation for a loan.

In step 110 the borrower registers with the system and qualifies for a credit rating. Credit ratings are used to categorise borrowers so that lenders can assess the risk of a loan to such borrowers. Credit scores and credit histories from a credit rating agency such as Equifax are used to assess the credit worthiness of loan applicants. Loan applicants are cast into categories A-E on the basis of their credit worthiness.

In addition to the Equifax credit score, a system of supplementary questions are used for checking credit worthiness; these questions also help identify potential money launderers and other potential fraudulent users.

At step 112, a form is displayed which may be viewed as a form on a page on an internet browser for example. In this form borrowers specify the loan amount and loan term they request a loan quotation for. In the present embodiment available loan term options are 12, 24 or 36 months.

In step 113 the borrower chooses whether to take out payment protection insurance on their loan. If accepted, the borrower will pay higher monthly repayments as the payment protection insurance premium will be added to the loan request amount, borrowed from lenders and repaid over the loan term.

At step 114 the borrower makes a final review of their request for a quotation and decides whether to proceed.

In step 115 any commission which is to be taken by the system is added to the borrower's requested loan amount. For example, the system may take a commission of 0.5% or 1% of the amount to be borrowed. The borrower's repayments then reflect the total amount borrowed, including any payment protection insurance premiums and commission fees.

As previously explained, the loan term requested and credit rating of the borrower, define the market to which the borrower's request for a quotation belongs. In step 116 the borrower's loan request is routed to the appropriate market based on their credit rating and the requested loan term. By way of example only in FIG. 3 the request is routed to market 14c.

Market 14c comprises loan offers from a plurality of lenders. These are matched with a borrower request by a matching engine that provides an output for supplying a borrower with a quotation for a loan. This quotation may be accepted or declined at step 118.

Declining the loan offer routes the borrower to step 120 whereby the borrower may offer feedback relating to the interest rate or monthly repayments that the borrower would have found acceptable. These feedback statistics are held in database 130 and may be viewed by lenders as a guide for setting their reserve rates. Whether or not the borrower offers feedback, they are returned to step 112 whereby they may make a new request for a quotation for a loan.

Accepting the loan offer routes the borrower to step 124 whereby the funds that comprise the completed borrower loan request are reserved or ring-fenced for the borrower while credit and integrity checks are performed with the information supplied by the borrower. Should the credit and integrity checks on the suitability of the borrower for the proposed loan fail then the match is unwound, the ring-fence removed and the funds returned to the market. Upon successful completion of these checks, in step 126 the loan is transferred to an account nominated by the borrower and the repayment plan agreed by the borrower will commence. Generally borrowers will pay back the loan in equal monthly installments for the term of the loan, at which time the loan will have been fully repaid; however other repayment strategies could be considered.

Matching Mechanism

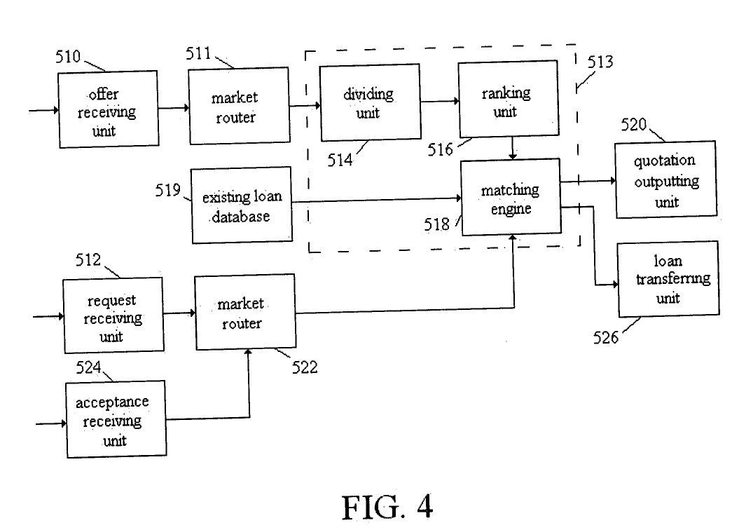

FIG. 4 shows a block diagram of an apparatus in an embodiment of the invention. The inputs to the apparatus are a plurality of offers from lenders 510a-510c and a request for a quotation 512 from a borrower.

Referring to FIG. 4, offer receiving unit 510 receives a lender offer from a lender. The lender offer includes the lender ID, the amount to be lent, the reserve rate of interest, and the market which is to be lent to. The offer receiving unit 510 passes the lender offer to market router 511, which routes the offer to the market specified by the lender. In FIG. 4 the chosen market is symbolically indicated by dashed line 513.

In market 513 the offer from the lender is passed to dividing unit 514. Dividing unit 514 splits the amount to be lent into separate amounts called loan units. Each loan unit represents the maximum amount that a lender can lend to any single borrower. In the present embodiment the size of a loan unit is either one fiftieth of the total loan amount offered by a lender, or $100, whichever is smaller. Therefore, any loan amount greater than $5000 will have a loan unit of $100, and any loan amount smaller than $5000 will have a loan unit of one fiftieth of the loan amount.

Thus a lender with a small offered loan amount cannot commit more than a certain fraction of their loan amount to any one borrower. This prevents a low-money lender from assuming too great a fractional risk in respect of any individual borrower. In particular it may be that one fiftieth of a loan amount is a suitable fractional cap. Equally it is preferable that a high-money lender does not commit more than a certain amount of money in absolute terms to any individual borrower. In the current embodiment $100 is considered a suitable cap, but other values such as $200 or $500 may also be suitable.

Each loan unit carries with it the lender ID which links the loan unit uniquely with the lender of origin. It also carries the reserve rate of the offer made by the lender. Loan units are calculated on the basis of the loan amount initially offered by a lender and are not re-evaluated should the loan amount become depleted by loans to borrowers. Loan units would only be re-evaluated if a loan offer was withdrawn and a new loan offer were made.

The plurality of loan units created by dividing unit 514 is transferred to ranking unit 516 for sorting. Ranking unit 516 creates a list comprising:

Lender ID

Loan unit size

Reserve rate offered by lender

Amount of loan unit available to borrow

Time of offer

Ranking unit 516 sorts this list in order of increasing reserve rate. Where two lenders have the same reserve rate, the lender which was first to offer the loan is ranked highest.

Request receiving unit 512 receives a request for a quotation from a borrower. The request includes the borrower ID, the borrower's credit rating, the amount to be borrowed, and the loan term. Based on the borrower's credit rating, market router 522 routes the request to the appropriate market. Within market 513 the borrower's request is passed to matching engine 518.

On receipt of a request for a quotation from a borrower, matching engine 518 matches loan units from ranking unit 516 with the borrower. The matching engine starts with the loan unit with the lowest reserve rate, and then adds loan units of increasingly high reserve rates. At each stage the amount of the loan unit which is available to borrow is added to a running total, until the requested amount to be borrowed is achieved.

At each stage the matching unit also checks the borrower ID to see whether the lender has already lent to the borrower. This is done by consulting a database of existing loans, which keeps a record of the lenders from which the borrower has already borrowed, and the borrowed amount. If the lender has already lent a full loan unit to the borrower, then no further amount can be lent, and the loan unit is not available to the borrower. In this case the matching engine moves on to the next ranked loan unit, without adding the loan unit from the lender who has already lent to the borrower. In some cases the lender may have already lent part of a loan unit to the borrower, in which case the remainder of the loan unit may be available.

If the matching engine 518 is able to assemble sufficient loan units to achieve the amount requested by the borrower, then it outputs a signal indicating that there has been a match to the quotation outputting unit 520. The matching engine also outputs to the quotation outputting unit the reserve rate of the last loan unit, or portion of a loan unit, that was needed to complete the loan. This is the rate of interest that will be paid by the borrower, and is also the rate that will be received by all lenders, once commission has been deducted. Thus all lenders will receive at least their reserve rate of interest, and in most cases they will receive more than their reserve rate.

The quotation outputting engine 520 outputs to the borrower a quotation based on the reserve rate of the last loan unit that was needed to complete the loan.

If the borrower accepts the quotation, then an acceptance will be received by acceptance receiving unit 524. The matching engine 518 will then run again and allocate loan units to the borrower. At this stage the loan units are removed from the market. Once the matching is complete, loan transfer unit 526 moves the loan units to the borrower's account, where they remain until the borrower is verified and able to transfer the money to their bank account.

If the matching engine 518 is not able to assemble sufficient loan units to achieve the amount requested by the borrower, then it outputs a signal indicating that there has been no match to the quotation outputting unit 520. The quotation outputting unit 520 then indicates to the borrower that their request cannot be met, and invites them to submit a revised request.

In the present embodiment all transactions are conducted in multiples of an amount called a loan lot. A loan lot thus represents the minimum building block of the system. In the present embodiment, loan lots are valued at $10 although other values may equally be chosen. Loan lots also carry with them a lender ID and reserve rate offer which links the loan lot uniquely with the lender of origin and the offer of the lender of origin.

When the matching engine is assembling the loan units, it may be that not all of the last loan unit is required to achieve the loan amount. In this case, the lender's remaining lots are retained by the lender, and continue to be offered to the market as components in the lender's loan units. If a lender has less than a complete loan unit left to lend to borrowers, the remaining lots will be available as a smaller than regular loan unit.

In the present embodiment an individual contract is created between the lender and the borrower for each loan lot, and, in the present embodiment, these contracts are not actually signed. In an alternative embodiment the borrower may automatically sign the contract using an automated signature tool that allows both lender and borrower to digitally sign all contracts without physically clicking on each one. For example, the borrower could click on a box to indicate acceptance of one contract, and then drag and drop the acceptance through to multiple other boxes. There could be one contract per loan lot, or one contract per amount actually lent by each lender to the borrower.

Generally borrowers undertake loan repayments in monthly installments. However it is possible for the borrower to pay off the loan amount in full before the term of their loan has elapsed. In this situation the borrower pays off the full balance of the loan without penalty and the monies are returned to the lenders of the loan lots that constituted the loan. These loan lots are then immediately and automatically re-offered to borrowers at the original reserve rate offered by the lender.

### Second Embodiment

In a second embodiment of the invention the lender selects the minimum interest rate that they are prepared to accept after statistical levels of bad debt have been taken into account. This is achieved by defining a minimum return rate, which is a minimum rate which a lender can expect to achieve after statistical levels of bad debt are taken into account. The system maintains a database holding statistics concerning historical bad debt in each market. Based on these statistics the system is able to estimate an expected return after bad debt for each market.

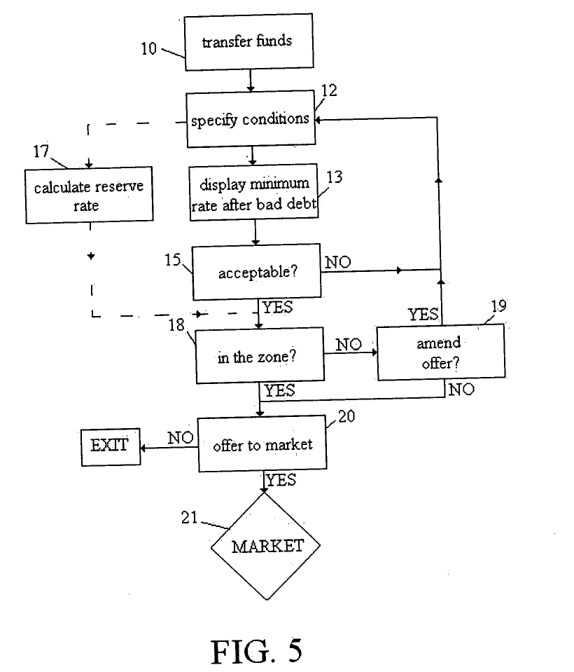

FIG. 5 shows a process that a lender goes through prior to making a loan offer in the second embodiment. As in the first embodiment, the lender must first complete step 10 by transferring funds to a holding account in order to proceed to the following steps.

At step 12 a form is displayed which may be viewed as a page on an Internet browser, for example. On this form the lender creates their loan offer by defining the following parameters:

The total amount of money they are prepared to lend

A reserve rate of interest

A market

In step 13 the system calculates a minimum return rate after bad debt, based on the specified reserve rate, and statistics concerning bad debt for the specified market. This is done by consulting a database which maintains statistics for bad debts in each market. The minimum return rate is then indicated to the lender. This rate represents the minimum rate the lender can expect to achieve in that particular market once bad debt has been taken into account.

By way of example, in markets considered to be low risk, the statistical likelihood of bad debt occurring is low. Therefore the relationship between minimum return rate after bad debt and reserve rate may be such that the minimum return rate after bad debt is only slightly less than the reserve rate. By contrast, in markets considered relatively high risk the relationship between minimum return rate after bad debt may be such that the minimum return rate after bad debt is significantly less than the reserve rate.

At step 15 the lender decides whether the minimum return rate after bad debt is acceptable. If not processing returns to step 12 and the lender can specify new conditions; otherwise processing proceeds to step 18.

As an alternative to the above, in step 12 the lender may directly specify a minimum return rate after bad debt. In this case, in step 17 the system calculates a reserve rate which does not include a provision for bad debt. This is again done by consulting the database holding bad debt statistics, and determining the reserve rate which would give the specified minimum return rate after bad debt. This calculated reserve rate is the rate at which the lender's money will be offered to the market.

In step 18 it is determined whether the lender's offer is “in the zone” in the same way as described above in the first embodiment. If a lender's offer is deemed to be “not in the zone” then they may choose either to amend or to continue with their offer at step 19. If the lender chooses to amend their offer they are routed back to step 12; otherwise they are routed to step 20. At step 4, the lender makes a final review of their loan offer and decides whether to proceed. In step 21 the lender's money is offered to the market at either the reserve rate specified by the lender, or, in the case where the lender has specified a minimum return rate after bad debt, at the reserve rate calculated by the system.

In the second embodiment the market operates in the same way as described above with reference to the first embodiment.

### Third Embodiment

In the first and second embodiments described above, a lender specifies a market to which they wish to lend. However it may be that there is little demand for money in that market, while another market may have a much higher demand. If the lender only offers to a market in which there is low demand, their money may remain in the market not earning interest. In the third embodiment of the invention, a lender is able to offer their money to multiple markets.

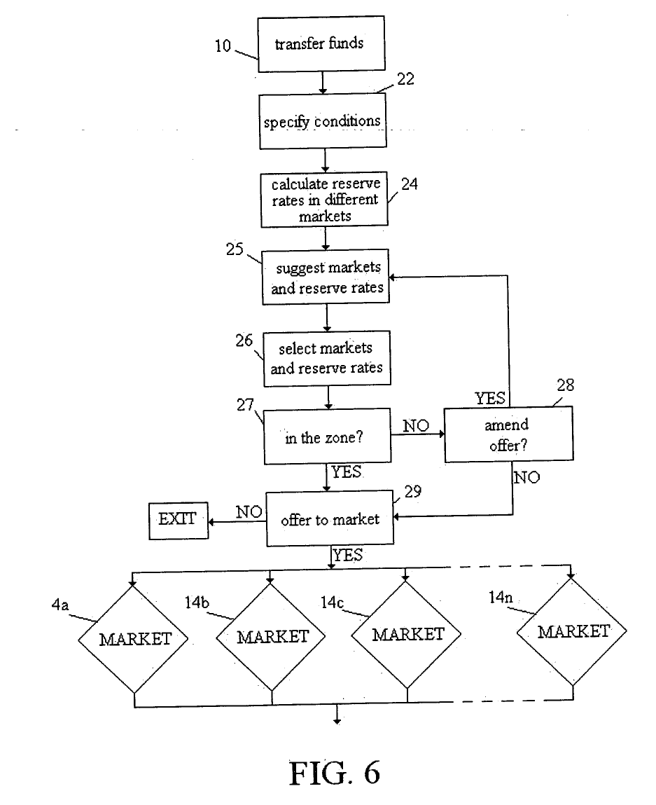

FIG. 6 shows a process that a lender goes through prior to making a loan offer in the third embodiment. As in the first and second embodiments, the lender must first complete step 10 by transferring funds to a holding account in order to proceed to the following steps.

At step 22 a form is displayed which may be viewed as a page on an internet browser, for example. On this form the lender creates their loan offer by defining the following parameters:

The total amount of money they are prepared to lend

A minimum return rate after bad debt

As an alternative the lender may specify a reserve rate of interest and a market, and the system may calculate a minimum return rate after bad debt in the same way as described above with reference to the second embodiment. The lender may then be asked whether they would like to see suggested rates for other markets. If the lender is not interested in other markets then processing passes to step 2 in FIG. 2, and the lender's money is only offered to the specified market. However, if the lender is potentially interested in other markets then processing passes to step 24.

In step 24 the system calculates suggested reserve rates in different markets. This is done by consulting the database holding bad debt statistics, and, for each market, determining the reserve rate which would give the specified minimum return rate after bad debt.

At step 25, these suggested reserve rates are proposed to the lender for all relevant markets. In step 26 the lender may choose to accept, decline or amend these suggested reserve rates in different markets. As long as at least one of the suggested reserve rates is accepted or amended by the lender then the lender will proceed to step 27.

By electing to proceed with a plurality of reserve rate offers to different markets (either as suggested or as amended), a lender offers their available funds to borrowers in markets 14a-14n. By electing to proceed with a single reserve rate offer to a single market a lender's funds are only offered to borrowers in that market, this is analogous with the first embodiment as depicted by FIG. 2.

Step 27 is an assessment of whether the lender is “in the zone” with the reserve rate of their offer or offers. This operates identically to step 2 of FIG. 2 if there is a single offer to a single market. If a lender has elected to proceed with a plurality of reserve rate offers to different markets, step 27 has the modification to step 2 that each of the reserve rate offers is compared with statistics of the relevant market to determine whether the offer is “in the zone”.

If any of the lender's offers are deemed to be “not in the zone” then they may choose to amend or continue with any offer at step 28. This exists merely by way of a guide and the lender is free to choose to continue with any offer even if it is deemed to be “not in the zone”.

At step 29 the lender makes a final assessment of their reserve rates before offering them to borrowers in the chosen market or markets.

Markets 14a-14n each comprise loan offers from a plurality of lenders to borrowers of known credit rating who have requested a loan of a certain term. In this embodiment the lender's money is made available to multiple markets using loan units in a similar way to that described above with reference to the first embodiment. However once a loan unit has been lent out it is removed from all markets.

It will be appreciated that the above embodiments are described by way of example only and modifications are possible within the spirit and scope of the attached claims. In particular, features of one embodiment may be applied to any of the other embodiments.

What is claimed is:

1. An automated method of matching lenders of money with borrowers of money, the method comprising the steps of:
receiving a plurality of offers, each offer being received from a lender of money, and each offer specifying a loan amount;
dividing the loan amount from each lender into a plurality of loan units, each loan unit representing a maximum amount that can be lent to one borrower;
receiving a request for a quotation from a borrower, the request specifying an amount to be borrowed;
matching loan units from a plurality of lenders with the borrower, wherein no more than one loan unit from any one lender is matched with the borrower; and
outputting to the borrower a quotation based on the matched loan units.

2. A method according to claim 1, wherein each lender specifies a reserve rate of interest, and each loan unit has the reserve rate of interest of the lender associated with it.

3. A method according to claim 2, wherein the matching step comprises matching loan units having the lowest reserve rate of interest with the borrower.

4. A method according to claim 3, further comprising the step of ranking loan units in order of lowest reserve rate of interest, wherein the step of matching loan units comprises matching loan units in accordance with their ranking.

5. A method according to claim 4, wherein loan units having the same reserve rate of interest are ranked in order of the time at which the offer was made.

6. A method according to claim 3, wherein the quotation specifies a rate of interest.

7. A method according to claim 6, wherein the specified rate of interest is the reserve rate of the loan unit having the highest reserve rate needed to achieve the amount to be borrowed.

8. A method according to claim 7, wherein all lenders having a loan unit matched to the borrower receive the specified rate of interest for the matched loan unit.

9. A method according to claim 2, wherein all lenders having a loan unit matched to the borrower receive the rate of interest specified by the lender, and the quotation specifies a rate of interest based on the rate of all matched lenders.

10. A method according to claim 1, wherein the matching step comprises matching part of a loan unit with the borrower.

11. A method according to claim 1, the method further comprising the step of dividing each of said plurality of loan units into a plurality of loan lots.

12. A method according to claim 1, further comprising the steps of:
maintaining statistics concerning a level of bad debt;
calculating an expected minimum return rate based on a reserve rate specified by a lender and the statistics concerning bad debt; and
outputting to a lender the expected minimum return rate.

13. A method according to claim 1, wherein the request for a quotation from a borrower specifies a loan term, and wherein each offer from a lender of money specifies a loan term.

14. A method according to claim 1, further comprising the step of determining a credit rating for the borrower, wherein each offer from a lender of money specifies a credit rating for prospective borrowers.

15. A method according to claim 1, wherein a plurality of markets are provided, with each market being defined by at least one of loan term, credit rating of the borrower, a characteristic of lenders, and a characteristic of borrowers.

16. A method according to claim 15, wherein a lender offers money to a plurality of markets.

17. A method according to claim 16, wherein the lender specifies a different reserve rate for each of a plurality of markets, and the loan amount is offered to each market at the specified reserve rate.

18. A method according to claim 16, the method further comprising the steps of:
maintaining statistics concerning the level of bad debt in each of a plurality of markets;
calculating a reserve rate for each market based on a minimum return rate specified by a lender and the statistics concerning bad debt for that market; and
outputting to a lender the calculated reserve rate for each market.

19. A method according to claim 1, further comprising the step of comparing the reserve rate offered by a lender with specified rates of interest of recently accepted quotations, whereby it may be determined whether the reserve rate offered by a lender is consistent with current trends.

20. A method according to claim 1, further comprising the step of adding commission to the amount to be borrowed specified by the borrower.

21. A method according to claim 1, further comprising the step of adding an insurance premium to the amount to be borrowed specified by the borrower.

22. A method according to claim 1, further comprising the step of receiving an acceptation of a quotation from a borrower and transferring matched loan units to a borrower's account.

23. A method according to claim 1, further comprising the steps of outputting terms of a contract for the loan to the borrower, and receiving an acceptance of the terms of said contract from the borrower.

24. A method according to claim 1, further comprising the steps of receiving a rejection of a quotation from a borrower and receiving feedback from the borrower in respect of a quotation that would have been acceptable.

25. A method according to claim 1, wherein the size of a loan unit is dependent on the size of the loan amount.

26. A method according to claim 25 wherein, if the loan amount is smaller than a predetermined value, then the loan units are set as a fraction of the loan amount, whereas if the loan amount is greater than or equal to the predetermined value then loan units are a fixed value.

27. A method according to claim 1, wherein the steps of the method are carried out by a computer.

28. A method according to claim 27, wherein the steps of receiving a plurality of offers, receiving a request from a borrower and outputting a quotation to the borrower are carried out over a network.

29. An automated method of matching lenders of money with borrowers of money, the method comprising the steps of:
receiving a plurality of offers, each offer being received from a lender of money, and each offer specifying a loan amount and a reserve rate of interest;
dividing the loan amount from each lender into a plurality of loan units, each loan unit representing a maximum amount that can be lent to one borrower;
receiving a request for a quotation from a borrower, the request specifying an amount to be borrowed;
matching loan units with the borrower in order to make up the amount to be borrowed, wherein loan units having the lowest reserve rate of interest are matched in order to achieve the amount to be borrowed, and wherein no more than one loan unit from any one lender is matched with the borrower; and
outputting to the borrower a quotation based on the reserve rate of interest of the loan unit having the highest reserve rate of interest needed to achieve the amount to be borrowed.

30. An automated method of matching lenders of money with borrowers of money, the method comprising the steps of:
providing a market in which lenders of money are matched with borrowers of money at agreed rates of interest;
maintaining statistics concerning agreed rates of interest at which money has been lent in the market;
receiving an offer from a lender, the offer specifying a reserve rate of interest;
comparing said reserve rate of interest specified by the lender with said statistics concerning agreed rates of interest at which money has been lent in the market; and
outputting to the lender a result of said comparison.

31. An automated method of matching lenders of money with borrowers of money, the method comprising the steps of:
providing a market in which lenders of money are matched with borrowers of money at agreed rates of interest;
receiving information from borrowers concerning rates at which they would be prepared to borrow;
maintaining statistics concerning rates at which borrowers would be prepared to borrow;
receiving an offer from a lender, the offer specifying a reserve rate of interest;
comparing the reserve rate of interest specified by the lender with said statistics concerning rates at which borrowers would be prepared to borrow; and
outputting to the lender a result of said comparison.

32. An automated method of matching lenders of money with borrowers of money, the method comprising the steps of:
providing a plurality of markets in each of which lenders of money are matched with borrowers of money at agreed rates of interest;
maintaining statistics concerning the level of bad debt in each of said plurality of markets;
receiving an offer from a lender, the offer specifying a minimum return rate that would be acceptable to the lender;
calculating a reserve rate for each market based on said minimum return rate specified by the lender and the statistics concerning bad debt for that market; and
outputting to the lender the calculated reserve rate for each market.

33. Apparatus which matches lenders of money with borrowers of money, the apparatus comprising:
an offer receiving unit which receives a plurality of offers, each offer being received from a lender of money, and each offer specifying a loan amount;
a dividing unit which divides the loan amount from each lender into a plurality of loan units, each loan unit representing a maximum amount that can be lent to one borrower;
a request receiving unit which receives a request for a quotation from a borrower, the request specifying an amount to be borrowed;
a matching engine which matches loan units from a plurality of lenders with the borrower, wherein no more than one loan unit from any one lender is matched with the borrower; and
an outputting unit which outputs to the borrower a quotation based on the matched loan units.

34. An apparatus according to claim 33, wherein the offer receiving unit receives a reserve rate of interest, specified by a lender, and each loan unit has the reserve rate of interest of the lender associated with it.

35. An apparatus according to claim 34, wherein said matching engine comprises a ranking unit that ranks loan units in order of lowest reserve rate of interest.

36. An apparatus according to claim 35, wherein the matching engine matches loan units in accordance with their rankings determined by the ranking unit.

37. An apparatus according to claim 36, wherein the outputting unit outputs a quotation comprising a specified rate of interest and wherein the specified rate of interest is the reserve rate of the loan unit having the highest reserve rate needed to achieve the amount to be borrowed.

38. An apparatus according to claim 37, wherein all lenders having a loan lot matched to the borrower receive the specified rate of interest for the matched loan lot.

39. A computer readable storage medium having stored thereon a computer program, the computer program comprising:
a program module which receives a plurality of offers, each offer being received from a lender of money, and specifying a loan amount;
a program module which divides the loan amount from each lender into a plurality of loan units, each loan unit representing a maximum amount that can be lent to one borrower;
a program module which receives a request for a quotation from a borrower, the request specifying an amount to be borrowed;
a program module which matches loan units from a plurality of lenders with the borrower, wherein no more than one loan unit from any one lender is matched with the borrower; and
a program module which outputs to the borrower a quotation based on the matched loan units.
